(19) United States
(12) Patent Application Publication
(10) Pub. No.: US 2007/0007470 A1
(43) Pub. Date: Jan. 11, 2007

(54) Air-conditioned tanning device

(75) Inventor: Walter Kratz, Lanaken-Neerharen (BE)

Correspondence Address: GREENBLUM & BERNSTEIN, P.L.C., 1950 ROLAND CLARKE PLACE, RESTON, VA, 20191, US

(73) Assignee: JK-HOLDING GmbH, Windhagen (DE)

(21) Appl. No.: 11/476,706

(22) Filed: Jun. 29, 2006

(30) Foreign Application Priority Data
Jun. 29, 2005 (DE) 10 2005 030 388.9

(51) Int. Cl. G01J 3/10

(52) U.S. Cl. 250/504 R

(57) ABSTRACT

A tanning device wherein the lower part of the device comprises outflow nozzles and/or outflow channels along at least a part of the longitudinal sides of the lying surface, which nozzles and/or channels are directed substantially towards the protecting surface of the upper part and/or wherein the lower part comprises an intermediate surface which is located between the lying surface and at least one set of radiators below the lying surface, said intermediate surface allowing to guide air in the space between the intermediate surface and the lying surface for modulating the temperature of the latter. This Abstract is not intended to define the invention disclosed in the specification, nor intended to limit the scope of the invention in any way.

### CROSS-REFERENCE TO RELATED APPLICATIONS

The present application claims priority under 35 U.S.C. § 119 of German Patent Application No. 10 2005 030 388.9, filed Jun. 29, 2005, the entire disclosure whereof is expressly incorporated by reference herein.

### BACKGROUND OF THE INVENTION

1. Field of the Invention

The present invention relates to a tanning device comprising an air-conditioning device. In particular, the present invention relates to a tanning device the air-conditioning of which is effected by means of devices which may be housed in the lower part of the tanning device.

2. Discussion of Background Information

Devices for tanning the body, in particular devices for tanning substantially the whole body, are broadly described in the state of the art. Usually, such tanning devices consist of a stable lower part allowing, due to its overall volume, to house substantially all technical appliances of the device, particularly the electrical appliances, switching and connecting devices, and of an upper part usually connected to one of the longitudinal sides of the lower part via hinges or hinged joints and turning or swiveling away from the lower part or towards the lower part so as to form a tanning space between both parts. In certain embodiments of the tanning device, the upper part may also be hanged up on a separate suspension liftably and lowerably, independently of the lower part. The suspension usually is either fixed to a branch standing on the same level as the lower part or fixed to a side wall or is hanging down from a device anchored to the ceiling, whereby the wall or the ceiling are part of the room where the tanning device is operated.

Above the space of the lower part suitable for housing the technical appliances, there is found a set, or there are found several sets, of radiation emitters or radiators arranged in a longitudinal direction of the tanning device, for example tubes or high pressure radiators emitting UV radiation having a tanning radiation portion, which radiation is emitted substantially towards the upper part of the tanning device onto a part of the body of a user of the tanning device, who is lying on a transparent lying surface allowing at least for the UV radiation emitted by the radiation-emitting tubes to pass. The radiators may allow either an emission of radiation for tanning all parts of the body of the user or may allow an emission of radiation for tanning certain parts of the body of the user, only, for example the legs, the torso and/or the shoulder.

In a corresponding manner, there is found, in the upper part (in the operation mode) above a protecting surface directed to the user and being arranged substantially parallel to the lying surface of the lower part and also being transparent for UV radiation, at least one set of radiators arranged in the longitudinal direction of the tanning device, for example tubes or high pressure radiators emitting radiation having a tanning portion of UV radiation, the radiation of which is emitted substantially into the direction of the lower part of the tanning device onto a part of the body of the user. In a preferred embodiment, there are found at least two sets of radiators emitting tanning UV radiation in the upper part of the tanning device, of which one, for example, serves the emission of UV radiation onto the body of the user, and the second serves the emission of UV radiation onto the face of the user.

In addition to the UV radiation and to the visible radiation, the UV radiator tubes and high pressure radiators emit a noticeable amount of infrared radiation during operation, which infrared radiation is felt by the user as warmth or heat, naturally. The heat radiation, felt to be pleasant in the cold time of the year or at the beginning of the tanning process (depending upon the individually different sensation), reaches unpleasant values in the further course of the tanning process in the inner part of the tanning device, particularly during the warm time of the year. This is the reason why tanning devices are provided with cooling and air conditioning devices already in the state of the art.

Thus, the state of the art describes a typical tanning device having air conditioning and cooling devices, the air conditioning devices being distributed over the whole apparatus in order to draw in as much fresh air as possible and supply it to outflow nozzles via isolated channels, such nozzles being located in the upper part of the tanning device, exclusively. Cold air generated in an air-conditioning cooler (which, according to the technical construction, is very voluminous and can be accommodated in the lower part of the tanning device, only) is added to the fresh air in accordance with individual needs, what requires a further isolation of the cooling pipes. In accordance with the experience, these devices achieve a cooling of air only, which cooled air is then blown onto the body of the user of the tanning device. A consistent cooling of the tanning space, i.e. of the space between the lower part and the upper part of the tanning device, where the user of the tanning device is lying in the course of the tanning procedure, cannot be achieved. This is not always felt to be pleasant and is, in single cases due to the draught generated, even felt to be unpleasant and, negatively lasting, affects the tanning experience. Moreover, outflow nozzles for cooling the face are always located directly on the left and right sides of the face and have to be adjusted in a cumbersome manner in accordance with the individually different sensation of a person. Thereafter, the nozzles blow cool air onto the ears, the nose and the mouth of the user. The direct blow onto the ears generates an unpleasantly loud noise of the air flow, making a relaxed tanning impossible and, additionally preventing an undisturbed reception of acoustic signals (e.g. music).

At the beginning of the tanning process, the user lies down to the lying surface of the tanning device which usually consists of a more or less smooth plastics material transparent at least for tanning UV radiation. The material is felt by the body of the user to be cold, at least in cases where the device was not in operation before the tanning procedure in question or where the radiators or burners emitting tanning radiation were switched off for a longer time. A pre-warming of the lying surface and, optionally, also of the tanning space of the tanning device could improve the comfort of the user. In the prior art, there were made already proposals for pre-warming the lying surface of a tanning device. In this respect, reference is made, for example, to the document DE-A 100 53 900.9, the entire disclosure whereof is expressly incorporated by reference herein.

In general, a modulation of the temperature, preferably a cooling, of the inner space of a tanning device and, in particular of the tanning space of a tanning device is desired.

It has now surprisingly been found that a consistent temperature modulation and, preferably, a cooling of the whole tanning space and optionally also of the lying surface of a tanning device can be achieved without the technology required for this purpose (e.g. (optionally isolated) pipes, nozzles, a nozzle control etc.) adding weight to the upper part of the tanning device, if the cooling air is supplied by means of outflow nozzles located along the lying surface at the lower part of the tanning device.

### SUMMARY OF THE INVENTION

The present invention provides a tanning device comprising:

a stable lower part accommodating one or more electrical appliances, switching devices and/or connecting devices; and

an upper part which may be connected to a longitudinal side of the lower part via one or more hinges or hinged joints and is capable, for example, by means of said hinges or hinged joints, of being turned or swiveled away from the lower part or towards the lower part to form a substantially tunnel-shaped tanning space between the lower part and the upper part and/or is capable of being lifted away from the lower part or lowered towards the lower part (for example, from a separate suspension) to form a substantially tunnel-shaped tanning space between the lower part and the upper part; wherein

the lower part comprises a lying surface for a user, which surface is transparent for at least tanning UV radiation and, below the lying surface, comprises at least one set of radiators which are arranged in a longitudinal direction of the tanning device for emitting radiation having at least a portion of tanning UV radiation directed into the direction of the upper part and/or at least to a part of a body of the user and which are connected directly or indirectly to the one or more electrical appliances, switching devices and/or connecting devices; and

the upper part comprises a protecting surface for the user, which surface is transparent for at least tanning UV radiation and, above the protecting surface, comprises at least one set of radiators which are arranged in a longitudinal direction of the tanning device for emitting radiation having at least a portion of tanning UV radiation directed towards the direction of the lower part and/or at least a part of the body of the user; and wherein

the lower part comprises at least one of

(i) one or more outflow nozzles and/or outflow channels along at least a part of the longitudinal sides of the lying surface, which nozzles or channels, respectively, are directed substantially towards the protecting surface of the upper part and feed an air flow into the tanning space, which air flow, after flowing through the tanning space, modulates the body temperature of the user,

(ii) an intermediate surface which is transparent for at least tanning UV radiation and is located between the lying surface and the at least one set of radiators below the lying surface for emitting radiation having at least a portion of tanning UV radiation, said intermediate surface being in a plane substantially parallel to the plane of the lying surface and allowing to guide air in a space between the intermediate surface and the lying surface for modulating the temperature of the latter, and

(iii) one or more outflow nozzles and/or outflow channels along at least a part of the longitudinal sides of the lying surface, which nozzles or channels, respectively, are directed substantially towards the protecting surface of the upper part and feed an air flow into the tanning space, which air flow modulates the temperature of the tanning space even at a time when the radiators below the lying surface and above the protecting surface are not working.

In one aspect, the device may be designed for tanning the whole body of the user.

In another aspect of the device, the lower part thereof may comprise (i) or may comprise (ii) or may comprise (iii), or may comprise any combination of two or three of (i) to (iii).

In another aspect of the device, from a viewpoint of the user the protecting surface of the upper part may be arched in a concave manner to form the tanning space having substantially the shape of a tunnel extending in the longitudinal direction of the tanning device.

In yet another aspect of the device, the protecting surface of the upper part may comprise an air diverter with a wedge shaped cross-section in the apex of the concave arch in the longitudinal direction of the upper part. The air diverter may be transparent for UV radiation and/or may be a part of the protecting surface. For example, the air diverter may be attached to the protecting surface (e.g., by means of an adhesive).

In another aspect, the air diverter may have a surface structure which is capable of distributing and/or swirling flowing air. For example, the air diverter may comprise recesses, spirals and/or waves for distributing and/or swirling the flowing air. In a still further aspect, air diverter may comprise elements for guiding flowing air separately to the body or separately to the face of the user.

In another aspect of the tanning device of the present invention, the lower part thereof may comprise one or more outflow nozzles and/or outflow channels along both longitudinal sides of the lying surface. For example, the lower part may comprise one outflow channel each along the whole length of both longitudinal sides.

In another aspect of the device of the present invention, the device may comprise (ii) and at least one of (i) and (iii) and a separate fan in the lower part may supply air into the space between the intermediate surface and the lying surface for modulating the temperature of the latter. For example, the separate fan in connection with an air conditioner and/or a cooling device may supply temperature-modulated air into the space between the intermediate surface and the lying surface for modulating the temperature of the latter. In one aspect, the temperature-modulating air may be guided through a passage from the tanning space into the space between the intermediate surface and the lying surface. For example, the temperature-modulating air may be guided through a passage located on a head side and/or a foot side of the lying surface from the tanning space into the space between the intermediate surface and the lying surface.

In another aspect of the device of the present invention, the device comprises at least (iii) and the air flow supplied may be drawn off on the head side and/or the foot side after flowing through the tanning space and may be supplied to a temperature-modulating air-conditioner which feeds temperature-modulated air flow back into the tanning space and/or the head side and/or the foot side of the tanning space of the tanning device may comprise a removable wall for closing the tanning space.

In another aspect of the device, temperature modulation may comprise a warming-up or a cooling of the air flow, compared to air surrounding the device. For example, the temperature modulation may comprise a cooling of the air flow. In another aspect, the temperature modulation may be controlled. For example, the temperature modulation may be controlled by a warming device and/or a cooling device, and a device for adding air from the environment to the circulating air flow.

The present invention also provides a process for modulating the temperature of the tanning space of a tanning device. The device comprises

a stable lower part accommodating one or more electrical appliances, switching devices and/or connecting devices; and

an upper part which may be connected to a longitudinal side of the lower part via one or more hinges or hinged joints and is capable (for example, by means of said hinges or hinged joints) of being turned or swiveled away from the lower part or towards the lower part to form a substantially tunnel-shaped tanning space between the lower part and the upper part and/or is capable of being lifted away from the lower part or lowered towards the lower part (for example, from a separate suspension) to form a substantially tunnel-shaped tanning space between the lower part and the upper part; wherein

the lower part comprises a lying surface for a user, which surface is transparent for at least tanning UV radiation and, below the lying surface, comprises at least one set of radiators which are arranged in the longitudinal direction of the tanning device for emitting radiation having at least a portion of tanning UV radiation directed into the direction of the upper part and/or at least to a part of a body of the user and which are connected directly or indirectly to the one or more electrical appliances, switching devices and/or connecting devices; and

the upper part comprises a protecting surface for the user, which surface is transparent for at least tanning UV radiation and, above the protecting surface, comprises at least one set of radiators which are arranged in a longitudinal direction of the tanning device for emitting radiation having at least a portion of tanning UV radiation directed to the direction of the lower part and/or at least a part of the body of the user; and wherein

an air flow is supplied into the tanning space substantially into the direction towards the protecting surface of the upper part of the tanning device by one or more outflow nozzles and/or one or more outflow channels arranged along at least the longitudinal sides of the lying surface of the lower part, said air flow modulating the temperature of the tanning space when flowing therethrough.

The present invention also provides a process for modulating the temperature of the body of a user in a tanning device. The tanning device comprises

a stable lower part accommodating one or more electrical appliances, switching devices and/or connecting devices; and

an upper part which may be connected to a longitudinal side of the lower part via one or more hinges or hinged joints and is capable (for example, by means of said hinges or hinged joints) of being turned or swiveled away from the lower part or towards the lower part to form a substantially tunnel-shaped tanning space between the lower part and the upper part and/or is capable of being lifted away from the lower part or lowered towards the lower part (for example, from a separate suspension) to form a substantially tunnel-shaped tanning space between the lower part and the upper part; wherein

the lower part comprises a lying surface for a user, which surface is transparent for at least tanning UV radiation and, below the lying surface, comprises at least one set of radiators which are arranged in a longitudinal direction of the tanning device for emitting radiation having at least a portion of tanning UV radiation directed into the direction of the upper part and/or at least to a part of the body of the user and which are connected directly or indirectly to the one or more electrical appliances, switching devices and/or connecting devices; and

the upper part comprises a protecting surface for the user, which surface is transparent for at least tanning UV radiation and, above the protecting surface, comprises at least one set of radiators which are arranged in the longitudinal direction of the tanning device for emitting radiation having at least a portion of tanning UV radiation directed to the direction of the lower part and/or at least a part of the body of the user; and wherein

an air flow is supplied into the tanning space substantially into a direction towards the protecting surface of the upper part of the tanning device by one or more outflow nozzles and/or one or more outflow channels arranged along at least the longitudinal sides of the lying surface of the lower part of the tanning device, said air flow modulating the temperature of the body of the user after flowing through the tanning space.

In one aspect of the above processes, in the course of modulating the temperature, the air flow may be warmed or cooled (preferably cooled), compared to the air surrounding the tanning device. In another aspect, the temperature modulation may be controlled. For example, the temperature modulation may be controlled by a warming device and/or a cooling device, and a device for adding air from the environment to the circulating air flow.

As set forth above, the invention relates to a tanning device, in particular for tanning the whole body of a user, said tanning device comprising
a stable lower part housing one or more electrical appliances, switching devices and/or connecting devices; and
an upper part which may be connected to one of the longitudinal sides of the lower part via hinges or hinged joints and, for example, by means of said hinges or hinged joints, is capable of turning or swiveling away from the lower part or towards the lower part so as to form a substantially tunnel-shaped tanning space between both parts and/or is capable of being lifted away from the lower part or lowered towards the lower part, for example, from a separate suspension, so as to form a substantially tunnel-shaped tanning space between both parts; wherein
the lower part has a lying surface for the user transparent at least for tanning UV radiation and, below the lying surface, has at least one set of radiators which are arranged in a longitudinal direction of the tanning device for emitting radiation having at least a portion of tanning UV radiation directed into the direction of the upper part and/or at least to a part of the body of the user and which are connected directly or indirectly to the electrical appliances, switching devices and/or connecting devices; and
the upper part has a protecting surface for the user transparent at least for tanning UV radiation and, above the protecting surface, has at least one set of radiators which are arranged in a longitudinal direction of the tanning device for emitting radiation having at least a portion of tanning UV radiation directed to the direction of the lower part and/or at least a part of the body of the user; and wherein
the lower part has outflow nozzles or outflow channels along at least a part of the longitudinal sides of the lying surface, which nozzles or channels, respectively, are directed substantially towards the protecting surface of the upper part and feed an air flow into the tanning space, which air flow modulates the user's body temperature after flowing through the tanning space.

The invention also relates to a tanning device, in particular for tanning the whole body of a user, said tanning device comprising
a stable lower part housing one or more electrical appliances, switching devices and/or connecting devices; and
an upper part which may be connected to one of the longitudinal sides of the lower part via hinges or hinged joints and, for example, by means of said hinges or hinged joints, is capable of turning or swiveling away from the lower part or towards the lower part so as to form a substantially tunnel-shaped tanning space between both parts and/or is capable of being lifted away from the lower part or lowered towards the lower part, for example, from a separate suspension, so as to form a substantially tunnel-shaped tanning space between both parts; wherein
the lower part has a lying surface for the user transparent at least for tanning UV radiation and, below the lying surface, has at least one set of radiators which are arranged in the longitudinal direction of the tanning device for emitting radiation having at least a portion of tanning UV radiation directed into the direction of the of the upper part and/or at least to a part of the body of the user and which are connected directly or indirectly to the electrical appliances, switching devices and/or connecting devices; and
the upper part has a protecting surface for the user transparent at least for tanning UV radiation and, above the protecting surface, has at least one set of radiators which are arranged in a longitudinal direction of the tanning device for emitting radiation having at least a portion of tanning UV radiation directed to the direction of the lower part and/or at least a part of the body of the user; and wherein
the lower part has an intermediate surface transparent for at least tanning UV radiation and located between the lying surface and the at least one set of radiators for emitting radiation having at least a portion of tanning UV radiation, said intermediate surface being in a plane substantially parallel to the plane of the lying surface and allowing to guide air in the space between the intermediate surface and the lying surface for modulating the temperature of the latter.

The invention also relates to a tanning device, particularly for tanning the whole body of a user, said tanning device comprising
a stable lower part housing one or more electrical appliances, switching devices and/or connecting devices; and
an upper part which may be connected to one of the longitudinal sides of the lower part via hinges or hinged joints and, for example, by means of said hinges or hinged joints, is capable of turning or swiveling away from the lower part or towards the lower part so as to form a substantially tunnel-shaped tanning space between both parts and/or is capable of being lifted away from the lower part or lowered towards the lower part, for example, from a separate suspension, so as to form a substantially tunnel-shaped tanning space between both parts; wherein
the lower part has a lying surface for the user transparent at least for tanning UV radiation and, below the lying surface, has at least one set of radiators which are arranged in a longitudinal direction of the tanning device for emitting radiation having at least a portion of tanning UV radiation directed into the direction of the of the upper part and/or at least to a part of the body of the user and which are connected directly or indirectly to the electrical appliances, switching devices and/or connecting devices; and
the upper part has a protecting surface for the user transparent at least for tanning UV radiation and, above the protecting surface, has at least one set of radiators which are arranged in a longitudinal direction of the tanning device for emitting radiation having at least a portion of tanning UV radiation directed to the direction of the lower part and/or at least a part of the body of the user; and wherein
the lower part has outflow nozzles or outflow channels along at least a part of the longitudinal sides of the lying surface, which nozzles or channels, respectively, are directed substantially towards the protecting surface of the upper part and feed an air flow into the tanning space, which air flow modulates the temperature of the tanning space even at a time when the radiators are not working.

In accordance with one aspect of the invention the modulation of the temperature comprises a warming-up or heating or, preferably, a cooling of the air flow, even more preferred compared to the air surrounding the tanning device.

The invention also relates to a process for modulating the temperature of the tanning space of a tanning device having
a stable lower part housing one or more electrical appliances, switching devices and/or connecting devices; and
an upper part which may be connected to one of the longitudinal sides of the lower part via hinges or hinged joints and, for example, by means of said hinges or hinged joints, is capable of turning or swiveling away from the lower part or towards the lower part so as to form a substantially tunnel-shaped tanning space between both parts and/or is capable of being lifted away from the lower part or lowered towards the lower part, for example, from a separate suspension, so as to form a substantially tunnel-shaped tanning space between both parts; wherein
the lower part has a lying surface for the user transparent at least for tanning UV radiation and, below the lying surface, has at least one set of radiators which are arranged in a longitudinal direction of the tanning device for emitting radiation having at least a portion of tanning UV radiation directed into the direction of the of the upper part and/or at least to a part of the body of the user and which are connected directly or indirectly to the electrical appliances, switching devices and/or connecting devices; and
the upper part has a protecting surface for the user transparent at least for tanning UV radiation and, above the protecting surface, has at least one set of radiators which are arranged in a longitudinal direction of the tanning device for emitting radiation having at least a portion of tanning UV radiation directed to the direction of the lower part and/or at least a part of the body of the user; and wherein
an air flow is supplied into the tanning space substantially into the direction to the protecting surface of the upper part of the tanning device by means of outflow nozzles or outflow channels arranged along at least the longitudinal sides of the lying surface of the lower part of the tanning device, said air flow modulating the temperature of the tanning space when flowing through, or wherein,
an air flow is supplied into the tanning space substantially into the direction to the protecting surface of the upper part of the tanning device by means of outflow nozzles or outflow channels arranged along at least the longitudinal sides of the lying surface of the lower part of the tanning device, said air flow modulating the temperature of the body of the user after flowing through the tanning space.

### BRIEF DESCRIPTION OF THE DRAWINGS

The present invention is further described in the detailed description which follows, in reference to the noted plurality of drawings by way of nonlimiting examples of exemplary embodiments of the present invention, in which like reference numerals represent similar parts throughout the several views of the drawings, and wherein:

FIG. 1 is a sectional view of the tanning device according to the invention from the head side thereof;

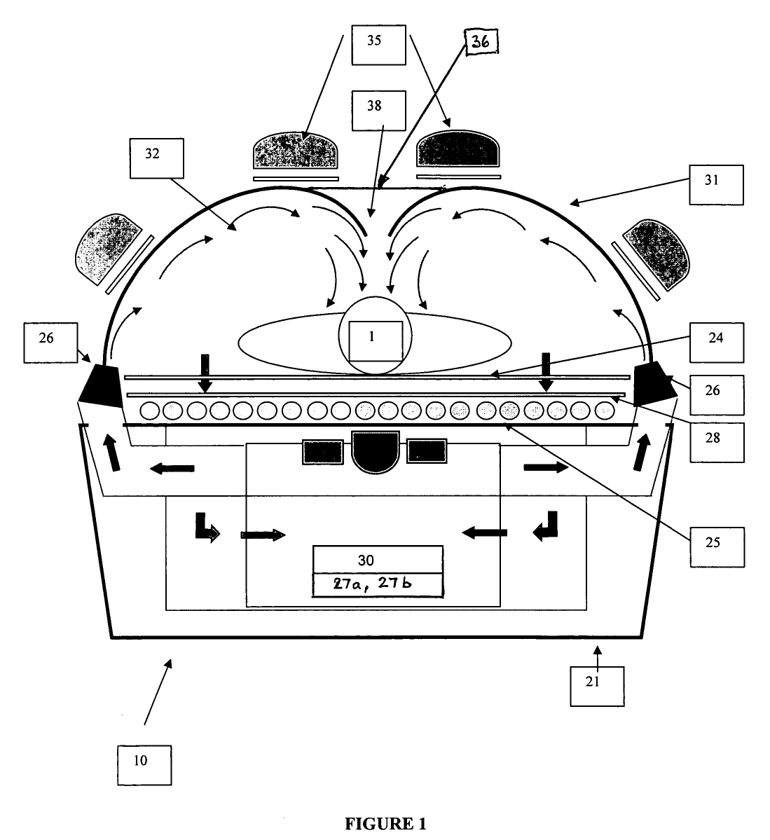

FIG. 2 is a sectional view of the tanning device according to the invention from the longitudinal side thereof;

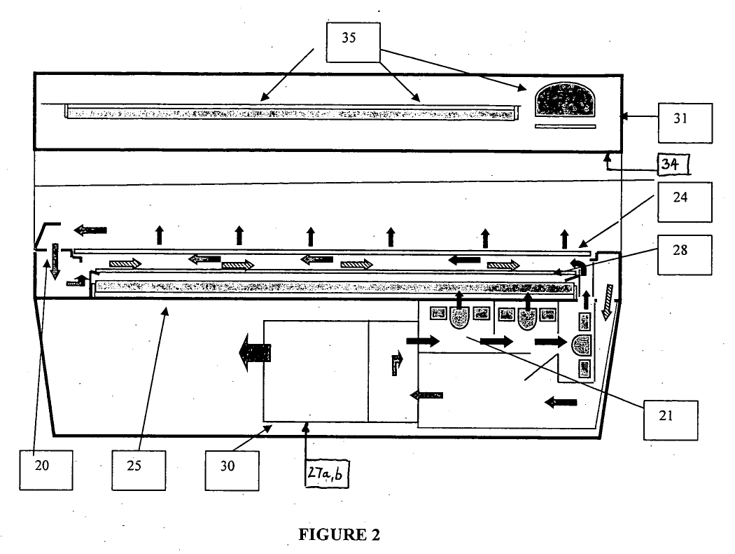

FIG. 3 is an elevational view of one embodiment of the tanning device according to the invention; and

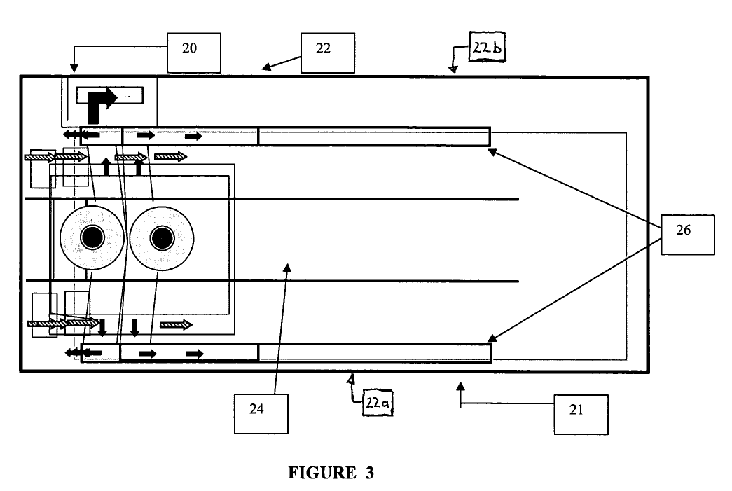

FIG. 4 is an elevational view of another embodiment of the tanning device of the invention.

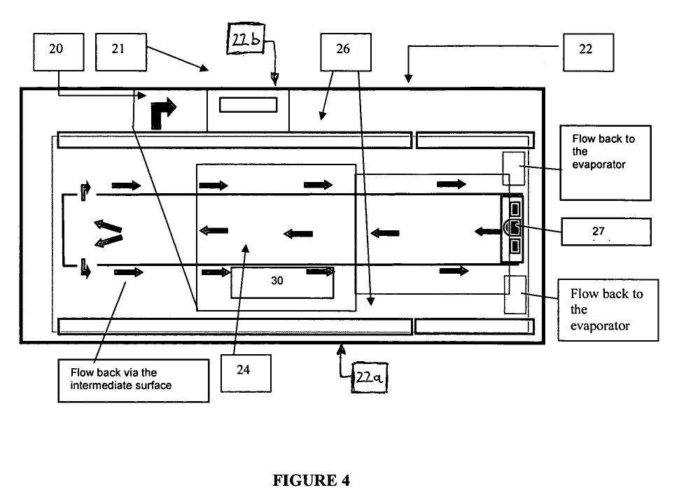

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

In the Figures, the tanning device of the invention bears the reference numeral 10; it preferably serves a tanning of the whole body of a user 1 by means of artificially generated radiation, which contains at least a portion of actinic radiation in the UV range (λ≦400 nm), which radiation has a tanning effect on the body of the user 1, i.e., stimulates the formation of melanin in the skin of the user. Within the scope of the invention there are also tanning devices 10 which may serve the tanning of the whole body of the user 1, but, at least for a certain time, are only used for tanning single parts of the body of the user 1, for example for tanning the face and/or the torso of the user 1.

Such tanning devices are known from the state of the art; usually, they comprise several parts which, in the majority of cases, but not exclusively, may be assigned either to a stable lower part 21 or to a movable upper part 31.

The lower part 21 usually serves the housing of the electrical appliances, switching devices and electrical, mechanical and flow connection devices required for operating the tanning device 10. These devices may be housed in the relatively voluminous lower part 21 more or less without being exposed to shakes and stress. In many cases, it is preferred that means or devices for modulating the temperature of or within the tanning device and/or parts thereof and/or corresponding fan devices be housed within the lower part 21. In the state of the art, repeatedly problems resulted from the fact that supply pipes of the air flow type (for example for supplying cooling air) had to be provided from the lower part 21 to the upper part 31 of the tanning device 10, and these supply pipes had to be isolated against a loss of heat (or better: cold). The majority of the other appliances required for operating the tanning device 10 are housed in the lower part of the tanning device 10, too, alone for reasons of their large weight.

For tanning devices of the type described above, there is provided, too, an upper part 31, which substantially corresponds to the lower part 21 with respect to the dimensions. Usually and also in accordance with the present invention, the upper part 31 is usually either connected to one of the longitudinal sides 22 of the lower part 21 via hinges or hinged joints and, by means of said hinges or hinged joints, may be turning or swiveling, namely away from the lower part 21 (when opening the tanning device 10), whereby the step of “getting in” of the user 1 into the tanning device 10 is made easier, or towards the lower part 21. In the course of such a turning or swiveling step of the upper part 31 towards the lower part 21, the tanning device 10 is closed before beginning the tanning procedure so as to form a substantially tunnel-shaped tanning space 32 between both parts, wherein the user 1 is lying during tanning.

In an alternative embodiment of the invention, the lower part 21 and the upper part 31 of the tanning device 10 may not be connected to each other via the hinges or hinged joints in a turning and swiveling manner. Rather, the upper part 31 may be fixed to a separate suspension, which, in turn, may be fixed either to a wall of the room, where the tanning device is standing, via a branch or may be fixed to a stand standing in the room where the tanning device is standing, or may be fixed to the ceiling of the room where the tanning device is standing. By means of the suspension, and suitable mechanical elements (optionally electronically controlled), the upper part 31 thus fixed may be lifted away from the lower part 21 of the tanning device 10 (for making easier the “getting in” of the user 1) or may be lowered towards the lower part 21. The movement of the upper part 31 towards the lower part 21 of the tanning device 10 results in a closing of the tanning device 10 before the beginning of the tanning procedure and in the formation of a substantially tunnel-shaped tanning space 32, where the user 1 is lying during the tanning procedure.

The lower part 21 of the tanning device 10 has a lying surface 24 for the user 1 transparent for at least tanning radiation. Usually, the lying surface 24 is transparent for the whole range of the radiation wavelengths generated in the tanning device. However, the lying surface 24 may have a selective transparency for a certain radiation. Particularly, there may be assigned a filtering function for UV radiation or visible radiation harming the body of the user 1 to the material of the lying surface 24. In order to obtain a tanning effect by the physiological generation of melanin, it is, however, required that the material of the lying surface 24 be sufficiently transparent at least for the tanning portion of the UV radiation; a 100% transparency is not required, but a transparency for the tanning portion of the UV radiation as large as possible is desired and striven for.

In the tanning device 10 according to the invention, there is provided, below the lying surface 24, at least one set of radiators 25 for emitting radiation having at least a portion of tanning UV radiation. From a practical point of view, the radiators are arranged in a longitudinal direction of the tanning device 10, namely in a direction extending from the head portion to the foot portion of the device. The radiators 25 may be one set of radiators 25 or may be several sets of radiators 25. In the latter case, the radiators 25 usually are arranged preferably in such a way that single parts or areas of the user's body can be subjected to radiation separately, for example the legs, the pelvis region, the back, the shoulder or several of the above parts of the user's body. The radiators 25 emit the radiation comprising at least a portion of the tanning radiation into the direction of the upper part 31 of the tanning device 10 and/or at least to a part of the body of the user 1 lying on the lying surface 24. A skilled person will appreciate that the radiators 25 are connected directly or indirectly to electrical appliances, (pre-) switching devices and/or connecting devices required for their operation. Such connections and switches are known from the state of the art and, hence, need no further explanation here.

The upper part 31, in a way comparable to the lower part 21 of the tanning device 10, has a protecting surface 34 on its lower side (i.e., the side showing to the user), which protecting surface 34 is transparent for at least tanning UV radiation. For reasons of saving weight, the protecting surface 34 is made of an (as much as possible) light-weight material, which also guarantees UV radiation transparency. The function of a filter for light having a specific wavelength may optionally be assigned to said material, as also in the case of the material for the lying surface 24 of the lower part 21 of the tanning device 10. In order to obtain a tanning effect by the physiological generation of melanin, it is, however, required that the material of the protecting surface 34 be sufficiently transparent at least for the tanning portion of the UV radiation. A 100% transparency is not required, but a transparency for the tanning portion of the UV radiation as large as possible is desired and striven for.

In the tanning device 10 according to the invention, there is provided, above the protection surface 24, at least one set of radiators 35 for emitting radiation having at least a portion of tanning UV radiation. From a practical point of view, the radiators are arranged in the longitudinal direction of the tanning device 10, namely in a direction extending from the head portion to the foot portion of the tanning device. The radiators 35 may be one set of radiators 35 or may be several sets of radiators 35. In the latter case, the radiators 35 usually are arranged preferably in such a way that single parts or areas of the user's body can be subjected to radiation separately, for example the legs, the pelvis region, the belly, the face or several of the above parts of the user's body. The radiators emit the radiation comprising at least a portion of the tanning radiation into the direction of the lower part 21 of the tanning device 10 and/or at least to a part of the body of the user 1 lying on the lying surface 24. A skilled person will appreciate that the radiators 35 are connected directly or indirectly to electrical appliances, (pre-) switching devices and/or connecting devices required for their operation. Such connections and switches are known from the state of the art and, hence, need no further explanation here.

In one embodiment of the invention, the lower part 21 has outflow nozzles 26 or outflow channels 26 along at least a part of the longitudinal sides 22a, 22b of the lying surface 24, through which air may flow out. Said outflow nozzles 26 and/or outflow channels 26, respectively, are directed substantially towards the protecting surface 34 of the upper part 31 of the tanning device and feed an air flow into the tanning space 32 of the tanning device 10, which air flow modulates the user's 1 body temperature after flowing through the tanning space 32.

The term “modulation of the temperature” or “modulates the temperature”, as used in the present specification and in the appended claims, means that, by technical measures, it is achieved that the temperature of the tanning device 10, of a part or of several parts thereof, as, for example (and not restricting) of the lying surface 24, of a head rest (not shown), of a foot rest (not shown) and/or of an area thereof, as, for example (and not restricting), of the tanning space 32, changes from a certain value T₁ establishing as a result of certain conditions as, for example, the surrounding environment temperature of the room where the tanning device 10 is operated, to a certain different value T₂ which the user of the tanning device 10 desires to establish or which, in accordance with the experience, is considered by the users to be pleasant, generally. For example, this may be the case if the operation of the tanning device 10 generates large amounts of heat by the heat emission by the radiators 25, 35, and such heat is unpleasant for the user with the consequence that he/she desires a temperature reduction. In such a case, the term “temperature modulation” is considered to mean a reduction of the temperature or a cooling down. Another case of cooling is the situation if, during summer time (or in warm areas), the tanning device is not operated in an air-conditioned room and, already at the beginning of the tanning procedure, there is reached a temperature exceeding the value pleasant for a user. Also in such a case, the term “temperature modulation” is considered to mean a reduction of the temperature or a cooling down. Another case of “cooling” occurs if the tanning device 10 is under operation for a certain time and the lying surface 24 is warmed up, by the heat radiation of the radiators 25, to a temperature exceeding the value considered pleasant by the next user. Also in such a case, the term “temperature modulation” is considered to mean a reduction of the temperature or a cooling down. On the contrary, the term “modulation of the temperature” is considered to mean a temperature increase or a step of warming up, if the tanning device 10 was not operated for a longer time and/or is operated in an air-conditioned (or cool or cooled) room, with the result that it is unpleasant for a user to lie down onto the cold lying surface 24 or into the cool tanning space 32, which case may happen in winter time, for example. In accordance with the invention, the preferred step of temperature modulation is a step of warming-up. It is even more preferred in the tanning device of the present invention that the temperature modulation may be controlled, preferably that the temperature modulation may be controlled by a warming and/or cooling device 27a and a device 27b for adding air to the circulating air flow from the environment surrounding the tanning device 10.

Outflow nozzles 26 or outflow channels 26, respectively, connected to fan device (not shown; located in the lower part 21) and temperature-modulation device (not shown; located in the lower part 21) via suitable pipes are arranged along at least a part of the longitudinal sides 22a, 22b of the lying surface 24, namely preferably on both sides of the lying surface 24. They may be single nozzles 26, i.e., substantially round or oval apertures, or may be elongated channels 26. Those are either concentrated to certain places along the longitudinal sides 22a, 22b of the lying surface 24, for example in order to more intensively modulate the temperature of the tanning space 32 at certain parts of the body of the user 1, for example near the user's face, or are distributed equally along one of (or along both of) the longitudinal sides 22a, 22b of the lying surface 24 in order to obtain a consistent temperature modulation of the tanning space 32 without creating any draught. In accordance with the invention, it is particularly preferred that the outflow nozzles 26 or outflow channels 26 are distributed equally along both longitudinal sides 22a, 22b of the lying surface 24. It is possible in accordance with the invention to provide outflow nozzles and outflow channels as well or only outflow nozzles 26 or only outflow channels 26 along the longitudinal sides 22a, 22b of the lying surface, while the order and exact location may be selected by a skilled person substantially freely and in accordance with the apparatus requirements. In a further preferred embodiment, it is also possible that one outflow channel 26 is located along each of the two longitudinal sides 22a, 22b of the lying surface 24 over substantially the whole length of each side of the lying surface 24.

The outflow nozzles or outflow channels 26 supply a temperature-modulated air flow into the tanning space 32 of the tanning device 10, for example a cool air flow. Said air flow is directed substantially into the direction of the protecting surface 34 of the upper part 31 of the tanning device 10. It is understood by “directed substantially into the direction of the protecting surface 34” that the air flow is not directed—as in usual tanning devices—directly onto the body of the user and does not effect a direct temperature modulation or cooling of the body of the user 1 which is felt to be unpleasant and is, now and then, accompanied by an interfering air flow noise. I accordance with the invention, the air flow flows into the tanning space 32 into the direction of its upper boundary in the form of the protecting surface 34 of the upper part 31 and reaches the body of the user 1 only after flowing through the whole tanning space 32. In this manner, surprisingly, not only the interfering air flow noise (for example at the ears of the user) is prevented, but also a smooth and pleasantly felt cooling is effected which is not experienced by the user as a draught.

In a further aspect of the invention, the protecting surface 34 of the upper part 31 transparent for at least tanning UV radiation for the user 1 is arched in a concave manner, from the viewpoint of the user 1, so as to form the tanning space 32 having substantially the shape of a tunnel extending in the longitudinal direction of the tanning device 10. The arched protecting surface of concave shape allows, in an advantageous manner, the air flow supplied by the outflow nozzles or outflow channels 26 to flow along the concave arch of the protecting surface 34 and thereby to be returned into the tanning space 32 in a consistent and directed manner.

In accordance with the invention, it is more preferred that the protecting surface 34 of the upper part 31 of the tanning device 10 transparent for at least tanning UV radiation has an air diverter 38 having a wedge shape cross-section and being applied to the apex 36 of the concave arch in the longitudinal direction. More preferably, the air diverter 38 is made of a material which—as the material of the protecting surface 34 for the user 1—is transparent for at least tanning UV radiation, in order to prevent diverter 38 from absorbing or shielding, respectively, a part of the tanning UV radiation emitted by the radiators 35. The air diverter 38 is particularly advantageous, because the air supplied by the outflow nozzles and/or outflow channels 26 into the tanning space 32 may be directed by it from the concave arch onto the user. In a particularly preferred embodiment, the air flowing in via the outflow nozzles and/or outflow channels 26 on both longitudinal sides 22a, 22b of the lying surface is swirled by means of the air diverter 38 in the middle of the tanning space 32, which swirling results into a temperature-modulated air flow at the body of the user 1, which is felt to be particularly pleasant.

In another, even more preferred embodiment of the invention practiced with a particular advantage, the air diverter 38 is a part of the protecting surface 34 transparent for at least tanning UV radiation. In such a case, the air diverter 38 is, if course, made of the same material as the protecting surface 34 and, hence, with respect to its transparency for at least tanning UV radiation, is identical to the transparency of the protecting surface 34. This embodiment is also advantageous in view of the manufacture, because the protecting surface 34 is integrally formed together with the air diverter 38 and, correspondingly, may be manufactured in one step.

In an alternative embodiment, the air diverter 38 may be applied onto the protecting surface 34 transparent for at least tanning UV radiation, which step may be performed as a supplementary step afterwards. In such a way, a retrofitting, by the air diverter 38, to the protecting surface 34 of the upper part 31 of the tanning device 10 becomes possible so that tanning devices already operating may be provided with the advantages of directing the air flow along the protecting surface 34. The application of the air diverter 38 to the protecting surface 34 may be performed on each desired route known to a skilled person. Particularly preferred is an application of the air diverter 38 to the protecting surface 34 of the upper part 31 of the tanning device 10 by means of an adhesive.

The air diverter 38 on the protecting surface 34 (or integrated into the protecting surface 34) transparent for at least tanning UV radiation may have a completely smooth surface. In accordance with the invention, it is, however, preferred that the air diverter 38 has a surface structure serving a distribution and/or swiveling of the flowing air. Such a surface structure may result into a better distribution of the air flow or even to its swiveling within the tanning space 32 of the upper part 31 of the tanning device 10, and a temperature modulation of the tanning space and of the body of the user 1 are achieved in an even better and more pleasant way thereby. The surface structure may be of any desired type known to a skilled person fur such purposes without that the invention is subject to any restriction of this feature. In an embodiment particularly advantageously realized, the air diverter 38 has recesses, spirals and/or waves serving for distributing and/or swirling the flowing air.

In an alternative advantageous embodiment of the invention, which may be put into practice together with the above-described embodiment, too, the air diverter 38 comprises a device by which the flowing air may be guided separately to the body or separately to the face of the user 1. Such devices are known to a skilled person, too, and either may be static or may be adjustable according to the individual desire so that the air flow may be guided, in an advantageous manner, to those parts of the body or of the face which are most pleasant to the user 1.

In a further advantageous embodiment of the invention, which may be put into practice together with the above-described embodiments of the tanning device, the lower part 21 of the tanning device 10 has an intermediate surface 28 transparent for at least tanning UV radiation and located between the lying surface 24 and the at least one set of radiators 25 for emitting radiation having at least a portion of tanning UV radiation, said intermediate surface 28 being in a plane substantially parallel to the plane of the lying surface 24 and allowing to guide air in the space between the intermediate surface 28 and the lying surface 24 with the aim of modulating the temperature of the lying surface 24. This embodiment of the invention takes the requirement into consideration that a temperature modulation of the lying surface may be desired in the sense of warming the cold lying surface 24 and in the sense of cooling the lying surface 24 warming up in the course of the operation of the radiators 25. Such a temperature modulation of the lying surface 24 may be effected by means of air having the temperature required for a temperature modulation and flowing through the space between the intermediate surface 28 and the lying surface 24.

In this embodiment of the invention, the intermediate surface 28 may comprise the same material as the lying surface 24. In view of the substantially less strict mechanical requirements, compared to the lying surface 24—the intermediate surface 28 is almost not put under mechanical stress—the intermediate surface may comprise a much less thick material or may comprise a material completely different from the material of the lying surface 24, provided that it is sufficiently transparent for at least tanning UV radiation. A 100% transparency is not required, but a transparency for the tanning portion of the UV radiation as large as possible is desired and striven for.

The exact position of the intermediate surface 28, relative to the lying surface 24, is not of decisive importance; however, it is preferred that the intermediate surface 28 is arranged in such a way that it is in a plane substantially parallel to the plane of the lying surface. This is advantageous because such an arrangement results into a space between the intermediate surface 28 and the lying surface 24 which has a substantially constant thickness, does not result into an air buildup during flowing of temperature-modulated air and, hence, allows a modulation of the air temperature of the lying surface 24 to a pleasant and desired value.

A temperature modulation of the lying surface 24 by means of the air flowing through the space between the lying surface 24 and the intermediate surface 28 may be achieved in the course of an operation of the tanning device 10, such a case frequently including a cooling of the lying surface 24 from the heat emitted by the radiators 25, or may be achieved before and/or after the operation of the tanning device 10, such a case including—according to the requirements—either a warming or a cooling or one after the other (e.g. first a warming, then a cooling). Thus, in a particularly advantageous manner, a modulation of the temperature of the tanning device 10 and, specifically, of the lying surface 24 adapted to every situation and in accordance with the individual desire of the user may be achieved, optionally together with a modulation of the temperature of the tanning space.

A modulation of the temperature of the air used for a temperature modulation may be achieved on each route conceivable and known to a skilled person. Particularly, technical components may be used for a temperature modulation which are described in the state of the art, for example in the document DE-A 100 53 900.9. In particularly preferred embodiments of the invention, the air is supplied into the space between the intermediate surface 28 and the lying surface 24 by means of a separate fan (preferably housed in the lower part 21 of the tanning device 10), and the temperature of the lying surface 24 is modulated by the air flowing through (and brought to the desired temperature, i.e. the temperature-modulated air). In a particularly advantageous manner, the separate fan in the tanning device 10 according to the invention is connected to a cooling or warming device or to an air-conditioning device 30 (preferably also housed in the lower part 21 of the tanning device 10). Air drawn in by the fan is temperature-modulated in the air-conditioning device 30 and is then supplied into the space between the intermediate surface 28 and the lying surface 24 so as to modulate the temperature of the latter. In so far, the air-conditioning device 30 may make use of all conceivable heat sources (e.g. the radiators 25) or heat consumers (e.g. for generating “cold”), which are described in the state of the art for purposes of heating/warming or cooling, in particular in connection with tanning devices, when warming up or cooling the air.

It is a further advantageous embodiment of the present invention—and may be applied as an alternative to the above-described embodiments or may be applied as a supplement to the above-described embodiments—that said air modulating the temperature of the lying surface 24 is guided through a passage 20 from the tanning space 32 into the space between the intermediate surface 28 and the lying surface 24. In such a case, the temperature-modulating (e.g. cooling) air of the tanning space 32 may subsequently be used for a temperature modulation (e.g. a cooling) of the lying surface 24, by drawing off such air from the tanning space 32 and passing it—via the passage 20—beneath the lying surface 24. In a particularly preferred embodiment, this is effected in a manner that said temperature-modulating air is guided through a passage 20 located on the head side or on the foot side of the lying surface 24 from the tanning space 32 into the space between the intermediate surface 28 and the lying surface 24. Thereby, a substantially comparable temperature modulation of the tanning space 32 and of the lying surface 24 is achieved, which step is particularly pleasant for the user.

By using the above-described features or a combination of any desired two or more features of the invention, particularly of the preferred features of the invention, a temperature modulation of the tanning space 32 and, optionally, also of the lying surface 24 is achieved which is pleasant for the user 1. Substantially all the components required for such a temperature modulation are housed in the lower part 21 of the tanning device 10 and, hence, do almost not add substantial weight to the weight of the upper part 31. Moreover, a modulation of the temperature of the body of the user 1—free of a draught—becomes possible, whereby the tanning experience is intensified and, in addition, a perception of acoustic signals (e.g. music) is not disturbed by air flow noise.

In a further embodiment of the invention of the tanning device 10 described above, the lower part 21 has an intermediate surface 28 transparent for at least tanning UV radiation and located between the lying surface 24 and the at least one set of radiators 25 for emitting radiation having at least a portion of tanning UV radiation, said intermediate surface 28 being in a plane substantially parallel to the plane of the lying surface 24 and allowing to guide air in the space between the intermediate surface 28 and the lying surface 24 for modulating the temperature of the latter.

This embodiment takes into consideration the requirement that a temperature modulation of the lying surface may be desired in the sense of warming the cold lying surface 24 and in the sense of cooling the lying surface 24 warming up in the course of an operation of the radiators 25. Such a temperature modulation of the lying surface 24 may be effected by means of air having the temperature required for a temperature modulation and flowing through the space between the intermediate surface 28 and the lying surface 24.

In this embodiment of the invention, the intermediate surface 28 may comprise the same material as the lying surface 24. In view of the substantially less strict mechanical requirements, compared to the lying surface 24—the intermediate surface 28 is almost not put under mechanical stress—the intermediate surface may comprise a much less thick material or may comprise a material completely different from the material of the lying surface 24, provided that it is sufficiently transparent for at least tanning UV radiation. A 100% transparency is not required, but a transparency for the tanning portion of the UV radiation as large as possible is desired and striven for.

The exact position of the intermediate surface 28, relative to the lying surface 24, is not of decisive importance; however, it is preferred that the intermediate surface 28 is arranged in such a way that it is in a plane substantially parallel to the plane of the lying surface. This is advantageous because such an arrangement results into a space between the intermediate surface 28 and the lying surface 24 which has a substantially constant thickness, does not result into an air buildup during flowing of temperature-modulated air and, hence, allows a modulation of the air temperature of the lying surface 24 to a pleasant and desired value.

A temperature modulation of the lying surface 24 by means of the air flowing through the space between the lying surface 24 and the intermediate surface 28 may be achieved in the course of an operation of the tanning device 10, such a case frequently including a cooling of the lying surface 24 from the heat emitted by the radiators 25, or may be achieved before and/or after the operation of the tanning device 10, such a case including—according to the requirements—either a warming or a cooling or one after the other (e.g. first a warming, then a cooling). Thus, in a particularly advantageous manner, a modulation of the temperature of the tanning device 10 and, specifically, of the lying surface 24 adapted to every situation and in accordance with the individual desire of the user may be achieved, optionally together with a modulation of the temperature of the tanning space.

A modulation of the temperature of the air used for a temperature modulation may be achieved on each route conceivable and known to a skilled person. Particularly, technical components may be used for a temperature modulation which are described in the state of the art, for example in the document DE-A 100 53 900.9. In particularly preferred embodiments of the invention, the air is supplied into the space between the intermediate surface 28 and the lying surface 24 by means of a separate fan (preferably housed in the lower part 21 of the tanning device 10), and the temperature of the lying surface 24 is modulated by the air flowing through (and brought to the desired temperature, i.e. the temperature-modulated air). In a particularly advantageous manner, the separate fan in the tanning device 10 according to the invention is connected to a cooling or warming device or to an air-conditioning device 30 (preferably also housed in the lower part 21 of the tanning device 10). Air drawn in by the fan is temperature-modulated in the air-conditioning device 30 and is then supplied into the space between the intermediate surface 28 and the lying surface 24 so as to modulate the temperature of the latter. In so far, the air-conditioning device 30 may make use of all conceivable heat sources (e.g. the radiators 25) or heat consumers (e.g. for generating “cold”), which are described in the state of the art for purposes of heating/warming or cooling, in particular in connection with tanning devices, when warming up or cooling the air.

It is a further advantageous embodiment of the present invention—and may be applied as an alternative to the above-described embodiments or may be applied as a supplement to the above-described embodiments—that said air modulating the temperature of the lying surface 24 is guided through a passage 20 from the tanning space 32 into the space between the intermediate surface 28 and the lying surface 24. In such a case, the temperature-modulating (e.g. cooling) air of the tanning space 32 may subsequently be used for a temperature modulation (e.g. a cooling) of the lying surface 24, by drawing off such air from the tanning space 32 and passing it—via the passage 20—beneath the lying surface 24. In a particularly preferred embodiment, this is effected in a manner that said temperature-modulating air is guided through a passage 20 located on the head side or on the foot side of the lying surface 24 from the tanning space 32 into the space between the intermediate surface 28 and the lying surface 24. Thereby, a substantially comparable temperature modulation of the tanning space 32 and of the lying surface 24 is achieved, which step is particularly pleasant for the user.

In a further preferred embodiment of the above-described invention, the lower part 21 has outflow nozzles 26 and/or outflow channels 26 along at least a part of the longitudinal sides 22a, 22b of the lying surface 24, through which air may flow out. Said outflow nozzles 26 and/or outflow channels 26, respectively, are directed substantially towards the protecting surface 34 of the upper part 31 of the tanning device and feed an air flow into the tanning space 32 of the tanning device 10, which air flow modulates the user's 1 body temperature after flowing through tanning space 32.

Outflow nozzles 26 or outflow channels 26, respectively, connected to fan device (not shown; located in the lower part 21) and temperature-modulation device (not shown; located in the lower part 21) via suitable pipes are arranged along at least a part of the longitudinal sides 22a, 22b of the lying surface 24, namely preferably on both sides of the lying surface 24. They may be single nozzles 26, i.e. substantially round or oval apertures, or may be elongated channels 26. Those are either concentrated to certain places along the longitudinal sides 22a, 22b of the lying surface 24, for example in order to more intensively modulate the temperature of the tanning space 32 at certain parts of the body of the user 1, for example near the user's face, or are distributed equally along one of (or along both of) the longitudinal sides 22a, 22b of the lying surface 24 in order to obtain a consistent temperature modulation of the tanning space 32 without creating any draught. In accordance with the invention, it is particularly preferred that the outflow nozzles 26 or outflow channels 26 be distributed equally along both longitudinal sides 22a, 22b of the lying surface 24. It is possible in accordance with the invention to provide outflow nozzles and outflow channels as well or only outflow nozzles 26 or only outflow channels 26 along the longitudinal sides 22a, 22b of the lying surface, while the order and exact location may be selected by a skilled person substantially freely and in accordance with the apparatus requirements. In a further preferred embodiment, it is also possible that one outflow channel 26 is located along each of the two longitudinal sides 22a, 22b of the lying surface 24 over substantially the whole length of each side of the lying surface.

The outflow nozzles or outflow channels 26 supply a temperature-modulated air flow into the tanning space 32 of the tanning device 10, for example a cool air flow. Said air flow is directed substantially into the direction of the protecting surface 34 of the upper part 31 of the tanning device 10. It is understood by “directed substantially into the direction of the protecting surface 34” that the air flow is not directed—as in usual tanning devices—directly onto the body of the user and does not effect a direct temperature modulation or cooling of the body of the user 1 which is felt to be unpleasant and is, now and then, accompanied by an interfering air flow noise. I accordance with the invention, the air flow flows into the tanning space 32 into the direction of its upper boundary in the form of the protecting surface 34 of the upper part 31 and reaches the body of the user 1 only after flowing through the whole tanning space 32. In this manner, surprisingly, not only the interfering air flow noise (for example in the ears of the user) is prevented, but also a smooth and pleasantly felt cooling is effected which is not experienced by the user as a draught.

In a further preferred embodiment of the invention, the protecting surface 34 of the upper part 31 transparent for at least tanning UV radiation for the user 1 is arched in a concave manner, from the viewpoint of the user 1, so as to form the tanning space 32 having substantially the shape of a tunnel extending in the longitudinal direction of the tanning device 10. The arched protecting surface of concave shape allows, in an advantageous manner, the air flow supplied by the outflow nozzles or outflow channels 26 to flow along the concave arch of the protecting surface 34 and thereby to be returned into the tanning space 32 in a consistent and directed manner.

In accordance with the invention, it is more preferred that the protecting surface 34 of the upper part 31 of the tanning device 10 transparent for at least tanning UV radiation has an air diverter 38 having a wedge shaped cross-section and being applied to the apex 36 of the concave arch in the longitudinal direction. More preferably, the air diverter 38 is made of a material which—as the material of the protecting surface 34 for the user 1—is transparent for at least tanning UV radiation, in order to prevent this device 38 from absorbing or shielding, respectively, a part of the tanning UV radiation emitted by the radiators 35. The air diverter 38 is particularly advantageous because the air supplied by the outflow nozzles and/or outflow channels 26 into the tanning space 32 may be directed by it from the concave arch onto the user. In a particularly preferred embodiment, the air flowing in via the outflow nozzles and/or outflow channels 26 on both longitudinal sides 22a, 22b of the lying surface is swirled by means of the air diverter 38 in the middle of the tanning space 32, which swirling results into a temperature-modulated air flow at the body of the user 1, which is felt to be particularly pleasant.

In another, even more preferred embodiment of the invention practiced with a particular advantage, the air diverter 38 is a part of the protecting surface 34 transparent for at least tanning UV radiation. In such a case, the air diverter 38 is, if course, made of the same material as the protecting surface 34 and, hence, with respect to its transparency for at least tanning UV radiation, is identical to the transparency of the protecting surface 34. This embodiment is also advantageous in view of the manufacture, because the protecting surface 34 is integrally formed together with the air diverter 38 and, correspondingly, may be manufacture in one step.

In an alternative embodiment, the air diverter 38 may be applied onto the protecting surface 34 transparent for at least tanning UV radiation, which step may be performed as a supplementary step afterwards. In such a way, a retrofitting, by the air diverter 38, to the protecting surface 34 of the upper part 31 of the tanning device 10 becomes possible so that tanning devices already operating may be provided with the advantages of directing the air flow along the protecting surface 34. The application of the air diverter 38 to the protecting surface 34 may be performed on each desired route known to a skilled person. Particularly preferred is an application of the air diverter 38 to the protecting surface 34 of the upper part 31 of the tanning device 10 by means of an adhesive.

The air diverter 38 on the protecting surface 34 (or integrated into the protecting surface 34) transparent for at least tanning UV radiation may have a completely smooth surface. In accordance with the invention, it is, however, preferred that the air diverter 38 has a surface structure serving a distribution and/or swiveling of the flowing air. Such a surface structure may result into a better distribution of the air flow or even to its swiveling within the tanning space 32 of the upper part 31 of the tanning device 10, and a temperature modulation of the tanning space and of the body of the user 1 are achieved in an even better and more pleasant way thereby. The surface structure may be of any desired type known to a skilled person fur such a purpose without that the invention is subject to any restriction of this feature. In an embodiment particularly advantageously realized, the air diverter 38 has recesses, spirals and/or waves serving for distributing and/or swirling the flowing air.

In an alternative advantageous embodiment of the invention, which may be put into practice together with the above-described embodiment, too, the air diverter 38 comprises a device by which the flowing air may be guided separately to the body or separately to the face of the user 1. Such devices are known to a skilled person, too, and may be static or may be adjustable according to the individual desire so that the air flow may be guided, in an advantageous manner, to those parts of the body or of the face which are most pleasant to the user 1.

By using the above-described features or a combination of any desired two or more features of the invention, particularly of the preferred features of the invention, a temperature modulation of the tanning space 32 and, optionally, also of the lying surface 24 is achieved which is pleasant for the user 1. Substantially all the components required for such a temperature modulation are housed in the lower part 21 of the tanning device 10 and, hence, do almost not add substantial weight to the weight of the upper part 31. Moreover, a modulation of the temperature of the body of the user 1—free of a draught—becomes possible, whereby the tanning experience is intensified and, in addition, a perception of acoustic signals (e.g. music) is not disturbed by air flow noise.

In a further preferred embodiment, the tanning device 10 according to the invention has a lower part 21 which has outflow nozzles 26 or outflow channels 26 along at least a part of the longitudinal sides 22a, 22b of the lying surface 24 through which air may flow out, which nozzles or channels 26, respectively, are directed substantially towards the protecting surface 34 of the upper part 31 of the tanning device and feed an air flow into the tanning space 32, which air flow modulates the temperature of the tanning space 32 even at a time when the radiators 25, 35 are not working. This concept of a more or less “closed” tanning space 32 allows a temperature modulation of the tanning space 32 even in cases where the tanning device 10 is not (yet) in operation. This may be useful, for example, in cases where the tanning device 10 was switched off for a longer time or is located in a cool or air-conditioned room or where the tanning device 10 was operated for a longer time under an emission of heat, is heated up and is to be cooled down for the next user, or where the tanning device 10 is located in a warm, non-air-conditioned room and is to be cooled, by temperature modulation, before a use by the next user.

Outflow nozzles 26 and/or outflow channels 26, respectively, connected to a fan device (not shown; located in the lower part 21) and a temperature-modulation device (not shown; located in the lower part 21) via suitable pipes are arranged along at least a part of the longitudinal sides 22a, 22b of the lying surface 24, namely preferably on both sides of the lying surface 24. They may be single nozzles 26, i.e. substantially round or oval apertures, or may be longish channels 26. Those are either concentrated to certain places along the longitudinal sides 22a, 22b of the lying surface 24, for example in order to more intensively modulate the temperature of the tanning space 32 at certain parts of the body of the user 1, for example near the user's face, or are distributed equally along one of (or along both on the longitudinal sides 22a, 22b of the lying surface 24 in order to obtain a consistent temperature modulation of the tanning space 32 without creating any draught. In accordance with the invention, it is particularly preferred that the outflow nozzles 26 or outflow channels 26 be distributed equally along both longitudinal sides 22a, 22b of the lying surface 24. It is possible in accordance with the invention to provide outflow nozzles and outflow channels as well or only outflow nozzles 26 or only outflow channels 26 along the longitudinal sides 22a, 22b of the lying surface, while the order and exact location may be selected by a skilled person substantially freely and in accordance with the apparatus requirements. In a further preferred embodiment, it is also possible that one outflow channel 26 is located along each of the two longitudinal sides 22a, 22b of the lying surface 24 over substantially the whole length of each side of the lying surface.

The outflow nozzles and/or outflow channels 26 supply a temperature-modulated air flow into the tanning space 32 of the tanning device 10, for example a cool air flow. Said air flow is directed substantially into the direction of the protecting surface 34 of the upper part 31 of the tanning device 10. It is understood by “directed substantially into the direction of the protecting surface 34” that the air flow is directed into the tanning space 32 directed to its upper boundary by the protection surface 34 of the upper part 31.

In an even more preferred embodiment of the invention, the air flow supplied via the outflow nozzles 26 or outflow channels 26 is drawn off on the head side or on the foot side of the lying surface 24 after flowing through the tanning space 32 and is supplied to a temperature-modulating air-conditioner 30 (optionally connected to a fan), said air-conditioner 30 feeding the temperature-modulated air flow back into the tanning space (32). In this manner, an energy-saving and economic circulation of the temperature-modulating air is established, by which a temperature modulation of the tanning space 32 can be achieved easily.

A further preferred embodiment of the invention serves to making the circulation of the air even more economic: The head side and/or the foot side of the tanning space 32 of the tanning device 10 each have a removable wall for closing the tanning space 32. The terms “closable” and “closing” as used in connection to this feature of the invention in the claims and in the specification do not mean an airtight closing of a volume space filled with air, which closing could be achieved in a tanning device under difficult technical conditions, only, but rather a far-reaching isolation of the tanning space 32 against air entering from the outside and not circulated in the sequence outflow nozzles and/or outflow channels 26→tanning space 32→drawing off air on the head side and/or foot side→fan and/or air conditioning→outflow nozzles and/or outflow channels 26 for avoiding heat or cold losses. The closable walls may comprise any desired material, and they particularly comprise a transparent, light-weight and UV radiation-insensitive material. Particularly preferably, a material selected from plastics materials, in particular poly(methylmethacrylate) (PMMA), and glass is used.

In a further preferred embodiment of the invention, the protecting surface 34 of the upper part 31 transparent for at least tanning UV radiation for the user 1 is arched in a concave manner, from the viewpoint of the user 1, so as to form the tanning space 32 having substantially the shape of a tunnel extending in the longitudinal direction of the tanning device 10. The arched protecting surface of concave shape allows, in an advantageous manner, the air flow supplied by the outflow nozzles or outflow channels 26 to flow along the concave arch of the protecting surface 34 and thereby to be returned into the tanning space 32 in a consistent and directed manner.

In accordance with the invention, it is more preferred that the protecting surface 34 of the upper part 31 of the tanning device 10 transparent for at least tanning UV radiation has an air diverter 38 having a wedge shaped cross-section and being applied to the apex 36 of the concave arch in the longitudinal direction. More preferably, the air diverter 38 is made of a material which—as the material of the protecting surface 34 for the user 1—is transparent for at least tanning UV radiation, in order to prevent this device 38 from absorbing or shielding, respectively, a part of the tanning UV radiation emitted by the radiators 35. The air diverter 38 is particularly advantageous because the air supplied by the outflow nozzles and/or outflow channels 26 into the tanning space 32 may be directed by it from the concave arch onto the user. In a particularly preferred embodiment, the air flowing in via the outflow nozzles and/or outflow channels 26 on both longitudinal sides 22a, 22b of the lying surface is swirled by means of the air diverter 38 in the middle of the tanning space 32, which swirling results into a temperature-modulated air flow at the body of the user 1, which is felt to be particularly pleasant.

In another, even more preferred embodiment of the invention practiced with a particular advantage, the air diverter 38 is a part of the protecting surface 34 transparent for at least tanning UV radiation. In such a case, the air diverter 38 is, if course, made of the same material as the protecting surface 34 and, hence, with respect to its transparency for at least tanning UV radiation, is identical to the transparency of the protecting surface 34. This embodiment is also advantageous in view of the manufacture, because the protecting surface 34 is integrally formed together with the air diverter 38 and, correspondingly, may be manufacture in one step.

In an alternative embodiment, the air diverter 38 may be applied onto the protecting surface 34 transparent for at least tanning UV radiation, which step may be performed as a supplementary step afterwards. In such a way, a retrofitting, by the air diverter 38, to the protecting surface 34 of the upper part 31 of the tanning device 10 becomes possible so that tanning devices already operating may be provided with the advantages of directing the air flow along the protecting surface 34. The application of the air diverter 38 to the protecting surface 34 may be performed on each desired route known to a skilled person. Particularly preferred is an application of the air diverter 38 to the protecting surface 34 of the upper part 31 of the tanning device 10 by means of an adhesive.

The air diverter 38 on the protecting surface 34 (or integrated into the protecting surface 34) transparent for at least tanning UV radiation may have a completely smooth surface. In accordance with the invention, it is, however, preferred that the air diverter 38 has a surface structure serving a distribution and/or swiveling of the flowing air. Such a surface structure may result into a better distribution of the air flow or even to its swiveling within the tanning space 32 of the upper part 31 of the tanning device 10, and a temperature modulation of the tanning space and of the body of the user 1 are achieved in an even better and more pleasant way thereby. The surface structure may be of any desired type known to a skilled person fur such a purpose without that the invention is subject to any restriction of this feature. In an embodiment particularly advantageously realized, the air diverter 38 has recesses, spirals and/or waves serving for distributing and/or swirling the flowing air.

In an alternative advantageous embodiment of the invention, which may be put into practice together with the above-described embodiment, too, the air diverter 38 comprises a device (not shown in the drawings) by which the flowing air may be guided separately to the body or separately to the face of the user 1. Such devices are known to a skilled person, too, and may be static or may be adjustable according to the individual desire so that the air flow may be guided, in an advantageous manner, to those parts of the body or of the face which are most pleasant to the user 1.

In a further advantageous embodiment of the invention, which may be put into practice together with the above-described embodiments of the tanning device, the lower part 21 of the tanning device 10 has an intermediate surface 28 transparent for at least tanning UV radiation and located between the lying surface 24 and the at least one set of radiators 25 for emitting radiation having at least a portion of tanning UV radiation, said intermediate surface 28 being in a plane substantially parallel to the plane of the lying surface 24 and allowing to guide air in the space between the intermediate surface 28 and the lying surface 24 with the aim of modulating the temperature of the lying surface 24. This embodiment of the invention takes the requirement into consideration that a temperature modulation of the lying surface may be desired in the sense of warming the cold lying surface 24 and in the sense of cooling the lying surface 24 warming up in the course of an operation of the radiators 25. Such a temperature modulation of the lying surface 24 may be effected by means of air having the temperature required for a temperature modulation and flowing through the space between the intermediate surface 28 and the lying surface 24.

In this embodiment of the invention, the intermediate surface 28 may comprise the same material as the lying surface 24. In view of the substantially less strict mechanical requirements, compared to the lying surface 24—the intermediate surface 28 is almost not put under mechanical stress—the intermediate surface may comprise a much less thick material or may comprise a material completely different from the material of the lying surface 24, provided that it is sufficiently transparent for at least tanning UV radiation. A 100% transparency is not required, but a transparency for the tanning portion of the UV radiation as large as possible is desired and striven for.

The exact position of the intermediate surface 28, relative to the lying surface 24, is not of decisive importance; however, it is preferred that the intermediate surface 28 is arranged in such a way that it is in a plane substantially parallel to the plane of the lying surface. This is advantageous because such an arrangement results in a space between the intermediate surface 28 and the lying surface 24 which has a substantially constant thickness, does not result into an air buildup during flowing of temperature-modulated air and, hence, allows a modulation of the air temperature of the lying surface 24 to a pleasant and desired value.

A temperature modulation of the lying surface 24 by means of the air flowing through the space between the lying surface 24 and the intermediate surface 28 may be achieved in the course of an operation of the tanning device 10, such a case frequently including a cooling of the lying surface 24 from the heat emitted by the radiators 25, or may be achieved before and/or after the operation of the tanning device 10, such a case including—according to the requirements—either a warming or a cooling or one after the other (e.g. first a warming, then a cooling). Thus, in a particularly advantageous manner, a modulation of the temperature of the tanning device 10 and, specifically, of the lying surface 24 adapted to every situation and in accordance with the individual desire of the user may be achieved, optionally together with a modulation of the temperature of the tanning space.

A modulation of the temperature of the air used for a temperature modulation may be achieved on each route conceivable and known to a skilled person. Particularly, technical components may be used for a temperature modulation which are described in the state of the art, for example in the document DE-A 100 53 900.9. In particularly preferred embodiments of the invention, the air is supplied into the space between the intermediate surface 28 and the lying surface 24 by means of a separate fan (preferably housed in the lower part 21 of the tanning device 10), and the temperature of the lying surface 24 is modulated by the air flowing through (and brought to the desired temperature, i.e. the temperature-modulated air). In a particularly advantageous manner, the separate fan in the tanning device 10 according to the invention is connected to a cooling or warming device or to an air-conditioning device 30 (preferably also housed in the lower part 21 of the tanning device 10). Air drawn in by the fan is temperature-modulated in the air-conditioning device 30 and is then supplied into the space between the intermediate surface 28 and the lying surface 24 so as to modulate the temperature of the latter. In so far, the air-conditioning device 30 may make use of all conceivable heat sources (e.g. the radiators 25) or heat consumers (e.g. for generating “cold”), which are described in the state of the art for purposes of heating/warming or cooling, in particular in connection with tanning devices, when warming up or cooling the air.

It is a further advantageous embodiment of the present invention—and may be applied as an alternative to the above-described embodiments or may be applied as a supplement to the above-described embodiments—that said air modulating the temperature of the lying surface 24 is guided through a passage 20 from the tanning space 32 into the space between the intermediate surface 28 and the lying surface 24. In such a case, the temperature-modulating (e.g. cooling) air of the tanning space 32 may subsequently be used for a temperature modulation (e.g. a cooling) of the lying surface 24, by drawing off such air from the tanning space 32 and passing it—via the passage 20—beneath the lying surface 24. In a particularly preferred embodiment, this is effected in a manner that said temperature-modulating air is guided through a passage 20 located on the head side or on the foot side of the lying surface 24 from the tanning space 32 into the space between the intermediate surface 28 and the lying surface 24. Thereby, a substantially comparable temperature modulation of the tanning space 32 and of the lying surface 24 is achieved, which step is particularly pleasant for the user.

By using the above-described features or a combination of any desired two or more features of the invention, particularly of the preferred features of the invention, a temperature modulation of the tanning space 32 and, optionally, also of the lying surface 24 is achieved which is pleasant for the user 1. Substantially all the components required for such a temperature modulation are housed in the lower part 21 of the tanning device 10 and, hence, do almost not add substantial weight to the weight of the upper part 31. Moreover, a modulation of the temperature of the body of the user 1—free of a draught—becomes possible, whereby the tanning experience is intensified and, in addition, a perception of acoustic signals (e.g. music) is not disturbed by air flow noise. In addition, the embodiment of the tanning device 10 according to the invention as described above is advantageous by that the temperature of the tanning space 32 may be modulated by applying low efforts, which fact is convenient in countries where the outside temperatures are relatively high and the tanning devices are not located in air-conditioned rooms. By supplying and drawing off temperature-modulating air by means of apparatus housed in the lower part of the tanning device 10, a short circulation route of the air is created where heat or “cold” losses are minor, which circulation may be controlled with simple, in part mechanical parts (e.g. flap valves) and which may be connected easily with a suitable temperature control.

The invention further relates to a process for modulating the temperature of the tanning space 32 of a tanning device 10 having
a stable lower part 21 housing one or more electrical appliances, switching devices and/or connecting devices; and
an upper part 31 either connected to one of the longitudinal sides 22 of the lower part 21 via hinges or hinged joints and, by means of said hinges or hinged joints, turning or swiveling away from the lower part 21 or towards the lower part 21 so as to form a substantially tunnel-shaped tanning space 32 between both parts or capable of being lifted away from the lower part 21 or lowered towards the lower part 21 from a separate suspension so as to form a substantially tunnel-shaped tanning space 32 between both parts; wherein
the lower part 21 has a lying surface 24 for the user 1 transparent at least for tanning UV radiation and, below the lying surface 24, has at least one set of radiators 25 which are arranged in a longitudinal direction of the tanning device 10 for emitting radiation having at least a portion of tanning UV radiation directed into the direction of the of the upper part 31 and/or at least to a part of the body of the user 1 and which are connected directly or indirectly to the electrical appliances, switching devices and/or connecting devices; and
the upper part 31 has a protecting surface 34 for the user 1 transparent at least for tanning UV radiation and, above the protecting surface 34, has at least one set of radiators 35 which are arranged in a longitudinal direction of the tanning device 10 for emitting radiation having at least a portion of tanning UV radiation directed to the direction of the lower part 21 and/or at least a part of the body of the user 1.

In the framework of the process of the invention, an air flow is supplied into the tanning space 32 substantially into the direction to the protecting surface 34 of the upper part 31 of the tanning device 10 by means of outflow nozzles 26 and/or outflow channels 26 arranged along at least the longitudinal sides 22a, 22b of the lying surface 24 of the lower part 21 of the tanning device 10, said air flow modulating the temperature of the tanning space 32 when flowing through.

In a further process in accordance with the invention, which relates to the tanning device 10 described above in detail and serves to a temperature modulation of the body of a user 1 of the tanning device 10, an air flow is supplied into the tanning space 32 substantially into the direction to the protecting surface 34 of the upper part 31 of the tanning device 10 by means of outflow nozzles 26 or outflow channels 26 arranged along at least the longitudinal sides 22a, 22b of the lying surface 24 of the lower part 21 of the tanning device 10, said air flow modulating the temperature of the body of the user 1 after flowing through the tanning space 32.

In an advantageous embodiment of the process according to the invention, there are provided, at the lower part 21 of the tanning device 10, outflow nozzles 26 and/or outflow channels 26 along at least a part of the longitudinal sides 22a, 22b of the lying surface 24, through which air may flow out. Said outflow nozzles 26 and/or outflow channels 26, respectively, are directed substantially towards the protecting surface 34 of the upper part 31 of the tanning device and feed an air flow into the tanning space 32 of the tanning device 10, which air flow modulates the user's 1 body temperature after flowing through tanning space 32, if a user 1 is present in the tanning space 32.

Outflow nozzles 26 or outflow channels 26, respectively, which are connected to a fan device (not shown; located in the lower part 21) and a temperature-modulation device (not shown; located in the lower part 21) via suitable pipes are arranged along at least a part of the longitudinal sides 22a, 22b of the lying surface 24, namely preferably on both sides of the lying surface 24. They may be single nozzles 26, i.e. substantially round or oval apertures, or may be longish channels 26. Those are either concentrated to certain places along the longitudinal sides 22a, 22b of the lying surface 24, for example in order to more intensively modulate the temperature of the tanning space 32 at certain parts of the body of the user 1, for example near the user's face, or are distributed equally along one of (or along both on the longitudinal sides 22a, 22b of the lying surface 24 in order to obtain a consistent temperature modulation of the tanning space 32 without creating any draught. In accordance with the invention, it is particularly preferred that the outflow nozzles 26 or outflow channels 26 be distributed equally along both longitudinal sides 22a, 22b of the lying surface 24. It is possible in accordance with the invention to provide outflow nozzles and outflow channels as well or only outflow nozzles 26 or only outflow channels 26 along the longitudinal sides 22a, 22b of the lying surface, while the order and exact location may be selected by a skilled person substantially freely and in accordance with the apparatus requirements. In a further preferred embodiment, it is also possible that one outflow channel 26 is located along each of the two longitudinal sides 22a, 22b of the lying surface 24 over substantially the whole length of each side of the lying surface.

The outflow nozzles or outflow channels 26 supply a temperature-modulated air flow into the tanning space 32 of the tanning device 10, for example a cool air flow. Said air flow is directed substantially into the direction of the protecting surface 34 of the upper part 31 of the tanning device 10. It is understood here by that the air flow is not directed—as in usual tanning devices directly onto the body of the user and does not effect a direct temperature modulation or cooling of the body of the user 1 which is felt to be unpleasant and is, now and then, accompanied by an interfering air flow noise. I accordance with the invention, the air flow flows into the tanning space 32 into the direction of its upper boundary in the form of the protecting surface 34 of the upper part 31 and reaches the body of the user 1 only after flowing through the whole tanning space 32. In this manner, surprisingly, not only the interfering air flow noise (for example in the ears of the user) is prevented, but also a smooth and pleasantly felt cooling is effected which is not experienced by the user as a draught.

In a further preferred embodiment of the invention, there is provided for a protecting surface 34 of the upper part 31 transparent for at least tanning UV radiation for the user 1 which is arched in a concave manner, from the viewpoint of the user 1, so as to form the tanning space 32 having substantially the shape of a tunnel extending in the longitudinal direction of the tanning device 10. The arched protecting surface of concave shape allows, in an advantageous manner, the air flow supplied by the outflow nozzles or outflow channels 26 to flow along the concave arch of the protecting surface 34 and thereby to be returned into the tanning space 32 in a consistent and directed manner.

In accordance with the invention, it is more preferred that there is provided, for the protecting surface 34 of the upper part 31 of the tanning device 10 transparent for at least tanning UV radiation, an air diverter 38 having a wedge shape cross-section and being applied to the apex 36 of the concave arch in the longitudinal direction. More preferably, the air diverter 38 is made of a material which—as the material of the protecting surface 34 for the user 1—is transparent for at least tanning UV radiation, in order to prevent this device 38 from absorbing or shielding, respectively, a part of the tanning UV radiation emitted by the radiators 35. The air diverter 38 is particularly advantageous because the air supplied by the outflow nozzles and/or outflow channels 26 into the tanning space 32 may be directed by it from the concave arch onto the user. In a particularly preferred embodiment, the air flowing in via the outflow nozzles and/or outflow channels 26 on both longitudinal sides 22a, 22b of the lying surface is swirled by means of the air diverter 38 in the middle of the tanning space 32, which swirling results into a temperature-modulated air flow at the body of the user 1, which is felt to be particularly pleasant.

In another, even more preferred embodiment of the invention practiced with a particular advantage, the air diverter 38 is a part of the protecting surface 34 transparent for at least tanning UV radiation. In such a case, the air diverter 38 is, if course, made of the same material as the protecting surface 34 and, hence, with respect to its transparency for at least tanning UV radiation, is identical to the transparency of the protecting surface 34. This embodiment is also advantageous in view of the manufacture, because the protecting surface 34 is integrally formed together with the air diverter 38 and, correspondingly, may be manufactured in one step.

In an alternative embodiment, the air diverter 38 may be applied onto the protecting surface 34 transparent for at least tanning UV radiation, which step may be performed as a supplementary step afterwards. In such a way, a retrofitting, by the air diverter 38, to the protecting surface 34 of the upper part 31 of the tanning device 10 becomes possible so that tanning devices already operating may be provided with the advantages of directing the air flow along the protecting surface 34. The application of the air diverter 38 to the protecting surface 34 may be performed on each desired route known to a skilled person. Particularly preferred is an application of the air diverter 38 to the protecting surface 34 of the upper part 31 of the tanning device 10 by means of an adhesive.

The air diverter 38 on the protecting surface 34 (or integrated into the protecting surface 34) transparent for at least tanning UV radiation may be provided to have a completely smooth surface. In accordance with the invention, it is, however, preferred that the air diverter 38 has a surface structure serving a distribution and/or swiveling of the flowing air. Such a surface structure may result into a better distribution of the air flow or even to its swiveling within the tanning space 32 of the upper part 31 of the tanning device 10, and a temperature modulation of the tanning space and of the body of the user 1 are achieved in an even better and more pleasant way thereby. The surface structure may be of any desired type known to a skilled person fur such a purpose without that the invention is subject to any restriction of this feature. In an embodiment particularly advantageously realized, the air diverter 38 has recesses, spirals and/or waves serving for distributing and/or swirling the flowing air.

In an alternative advantageous embodiment of the invention, which may be put into practice together with the above-described embodiment, too, the air diverter 38 may be provided to comprise a device by which the flowing air may be guided separately to the body or separately to the face of the user 1. Such devices are known to a skilled person, too, and may be static or may be adjustable according to the individual desire so that the air flow may be guided, in an advantageous manner, to those parts of the body or of the face which are most pleasant to the user 1.

In a further advantageous embodiment of the invention, which may be put into practice together with the above-described embodiments of the tanning device, the lower part 21 of the tanning device 10 is provided to have an intermediate surface 28 transparent for at least tanning UV radiation and located between the lying surface 24 and the at least one set of radiators 25 for emitting radiation having at least a portion of tanning UV radiation, said intermediate surface 28 being in a plane substantially parallel to the plane of the lying surface 24 and allowing to guide air in the space between the intermediate surface 28 and the lying surface 24 with the aim of modulating the temperature of the lying surface 24. This embodiment of the invention takes the requirement into consideration that a temperature modulation of the lying surface may be desired in the sense of warming the cold lying surface 24 and in the sense of cooling the lying surface 24 warming up in the course of an operation of the radiators 25. Such a temperature modulation of the lying surface 24 may be effected by means of air having the temperature required for a temperature modulation and flowing through the space between the intermediate surface 28 and the lying surface 24.

In this embodiment of the invention, the intermediate surface 28 may comprise the same material as the lying surface 24. In view of the substantially less strict mechanical requirements, compared to the lying surface 24—the intermediate surface 28 is almost not put under mechanical stress—the intermediate surface may comprise a much less thick material or may comprise a material completely different from the material of the lying surface 24, provided that it is sufficiently transparent for at least tanning UV radiation. A 100% transparency is not required, but a transparency for the tanning portion of the UV radiation as large as possible is desired and striven for.

The exact position of the intermediate surface 28, relative to the lying surface 24, is not of decisive importance; however, it is preferred that the intermediate surface 28 is arranged in such a way that it is in a plane substantially parallel to the plane of the lying surface. This is advantageous because such an arrangement results into a space between the intermediate surface 28 and the lying surface 24 which has a substantially constant thickness, does not result into an air buildup during flowing of temperature-modulated air and, hence, allows a modulation of the air temperature of the lying surface 24 to a pleasant and desired value.

A temperature modulation of the lying surface 24 by means of the air flowing through the space between the lying surface 24 and the intermediate surface 28 may be achieved in the course of an operation of the tanning device 10, such a case frequently including a cooling of the lying surface 24 from the heat emitted by the radiators 25, or may be achieved before and/or after the operation of the tanning device 10, such a case including—according to the requirements—either a warming or a cooling or one after the other (e.g. first a warming, then a cooling). Thus, in a particularly advantageous manner, a modulation of the temperature of the tanning device 10 and, specifically, of the lying surface 24 adapted to every situation and in accordance with the individual desire of the user may be achieved, optionally together with a modulation of the temperature of the tanning space.

A modulation of the temperature of the air used for a temperature modulation may be achieved on each route conceivable and known to a skilled person. Particularly, technical components may be used for a temperature modulation which are described in the state of the art, for example in the document DE-A 100 53 900.9. In particularly preferred embodiments of the invention, the air is supplied into the space between the intermediate surface 28 and the lying surface 24 by means of a separate fan (preferably housed in the lower part 21 of the tanning device 10), and the temperature of the lying surface 24 is modulated by the air flowing through (and brought to the desired temperature, i.e. the temperature-modulated air). In a particularly advantageous manner, the separate fan in the tanning device 10 according to the invention is connected to a cooling or warming device or to an air-conditioning device 30 (preferably also housed in the lower part 21 of the tanning device 10). Air drawn in by the fan is temperature-modulated in the air-conditioning device 30 and is then supplied into the space between the intermediate surface 28 and the lying surface 24 so as to modulate the temperature of the latter. In so far, the air-conditioning device 30 may make use of all conceivable heat sources (e.g. the radiators 25) or heat consumers (e.g. for generating “cold”), which are described in the state of the art for purposes of heating/warming or cooling, in particular in connection with tanning devices, when warming up or cooling the air.

It is a further advantageous embodiment of the present invention—and may be applied as an alternative to the above-described embodiments or may be applied as a supplement to the above-described embodiments—that said air modulating the temperature of the lying surface 24 is guided through a passage 20 from the tanning space 32 into the space between the intermediate surface 28 and the lying surface 24. In such a case, the temperature-modulating (e.g. cooling) air of the tanning space 32 may subsequently be used for a temperature modulation (e.g. a cooling) of the lying surface 24, by drawing off such air from the tanning space 32 and passing it—via the passage 20—beneath the lying surface 24. In a particularly preferred embodiment, this is effected in a manner that said temperature-modulating air is guided through a passage 20 located on the head side or on the foot side of the lying surface 24 from the tanning space 32 into the space between the intermediate surface 28 and the lying surface 24. Thereby, a substantially comparable temperature modulation of the tanning space 32 and of the lying surface 24 is achieved, which step is particularly pleasant for the user.

In a further preferred embodiment of the process according to the invention, in the course of modulating the temperature, the air flow (optionally circulated) is warmed, compared to the air surrounding the tanning device 10. It is even more preferred that the air flow (optionally circulated) is cooled, compared to the air surrounding the tanning device.

A large practical advantage may be derived from such processes according to the invention, where the temperature modulation is controlled, and even more preferably wherein the temperature modulation is controlled by a warming and/or cooling device 27a and/or a device 27b for adding air from the environment to the circulating air flow (said cooling device 27a being per se known and, even more preferred, being housed in the lower part 21 of the tanning device 10). In such a manner, a short circulation is created which does not generate heat or “cold” losses, which circulation may be controlled by simple, in part mechanical components as, for example, flap valves which may be connected to a temperature control, as the case may be.

By using the above-described features or a combination of any desired two or more features of the invention, particularly of the preferred features of the invention, a temperature modulation of the tanning space 32 and, optionally, also of the lying surface 24 is achieved which is pleasant for the user 1. Substantially all the devices required for such a temperature modulation are housed in the lower part 21 of the tanning device 10 and, hence, do almost not add substantial weight to the weight of the upper part 31. Moreover, a modulation of the temperature of the body of the user 1—free of a draught—becomes possible, whereby the tanning experience is intensified and, in addition, a perception of acoustic signals (e.g. music) is not disturbed by air flow noise.

It is noted that the foregoing examples have been provided merely for the purpose of explanation and are in no way to be construed as limiting of the present invention. While the present invention has been described with reference to an exemplary embodiment, it is understood that the words that have been used are words of description and illustration, rather than words of limitation. Changes may be made, within the purview of the appended claims, as presently stated and as amended, without departing from the scope and spirit of the present invention in its aspects. Although the invention has been described herein with reference to particular means, materials and embodiments, the invention is not intended to be limited to the particulars disclosed herein. Instead, the invention extends to all functionally equivalent structures, methods and uses, such as are within the scope of the appended claims.

What is claimed is:

1. A tanning device comprising:
a stable lower part accommodating one or more electrical appliances, switching devices and/or connecting devices; and
an upper part which is at least one of capable of being turned or swiveled away from the lower part or towards the lower part to form a substantially tunnel-shaped tanning space between the lower part and the upper part and capable of being lifted away from the lower part or lowered towards the lower part to form a substantially tunnel-shaped tanning space between the lower part and the upper part; wherein
the lower part comprises a lying surface for a user, which surface is transparent for at least tanning UV radiation and, below the lying surface, comprises at least one set of radiators which are arranged in a longitudinal direction of the tanning device for emitting radiation having at least a portion of tanning UV radiation directed into a direction of the upper part and/or at least to a part of a body of the user and which are connected directly or indirectly to the one or more electrical appliances, switching devices and/or connecting devices; and
the upper part comprises a protecting surface for the user, which surface is transparent for at least tanning UV radiation and, above the protecting surface, comprises at least one set of radiators which are arranged in a longitudinal direction of the tanning device for emitting radiation having at least a portion of tanning UV radiation directed to a direction of the lower part and/or at least a part of the body of the user; and wherein
the lower part comprises at least one of (i) one or more outflow nozzles and/or outflow channels along at least a part of longitudinal sides of the lying surface, which nozzles or channels, respectively, are directed substantially towards the protecting surface of the upper part and feed an air flow into the tanning space, which air flow, after flowing through the tanning space, modulates a body temperature of the user, (ii) an intermediate surface which is transparent for at least tanning UV radiation and is located between the lying surface and the at least one set of radiators below the lying surface for emitting radiation having at least a portion of tanning UV radiation, said intermediate surface being in a plane substantially parallel to a plane of the lying surface and allowing to guide air in a space between the intermediate surface and the lying surface for modulating a temperature of the latter, and (iii) one or more outflow nozzles and/or outflow channels along at least a part of longitudinal sides of the lying surface, which nozzles or channels, respectively, are directed substantially towards the protecting surface of the upper part and feed an air flow into the tanning space, which air flow modulates a temperature of the tanning space even at a time when the radiators below the lying surface and above the protecting surface are not working.

2. The device of claim 1, wherein the device is designed for tanning a whole body of the user.

3. The device of claim 1, wherein the lower part comprises (i).

4. The device of claim 1, wherein the lower part comprises (ii).

5. The device of claim 1, wherein the lower part comprises (iii).

6. The device of claim 1, wherein the lower part comprises (i) and (ii).

7. The device of claim 1, wherein the lower part comprises (i) and (iii).

8. The device of claim 1, wherein the lower part comprises (ii) and (iii).

9. The device of claim 1, wherein the lower part comprises (i), (ii) and (iii).

10. The device of claim 1, wherein from a viewpoint of the user the protecting surface of the upper part is arched in a concave manner to form the tanning space having substantially a shape of a tunnel extending in a longitudinal direction of the tanning device.

11. The device of claim 10, wherein the protecting surface of the upper part comprises an air diverter with a substantially wedge shaped cross-section in an apex of a concave arch in the longitudinal direction of the upper part.

12. The device of claim 11, wherein the air diverter is transparent for UV radiation.

13. The device of claim 11, wherein the air diverter is a part of the protecting surface.

14. The device of claim 11, wherein the air diverter is attached to the protecting surface.

15. The device of claim 14, wherein the air diverter is attached to the protecting surface by an adhesive.

16. The device of claim 11, wherein the air diverter has a surface structure which is capable of at least one of distributing and swirling flowing air.

17. The device of claim 16, wherein the air diverter comprises at least one of recesses, spirals and waves for at least one of distributing and swirling the flowing air.

18. The device of claim 11, wherein the air diverter comprises elements for guiding flowing air separately to a body or separately to a face of the user.

19. The device of claim 1, wherein the lower part comprises at least one of one or more outflow nozzles and one or more outflow channels along both longitudinal sides of the lying surface.

20. The device of claim 19, wherein the lower part comprises one outflow channel each along substantially a whole length of both longitudinal sides.

21. The device of claim 6, wherein a separate fan in the lower part supplies air into the space between the intermediate surface and the lying surface for modulating a temperature of the latter.

22. The device of claim 21, wherein the separate fan in connection with an air conditioner and/or a cooling device supplies temperature-modulated air into the space between the intermediate surface and the lying surface for modulating the temperature of the latter.

23. The device of claim 21, wherein the temperature-modulating air is guided through a passage from the tanning space into the space between the intermediate surface and the lying surface.

24. The device of claim 23, wherein said temperature-modulating air is guided through a passage located on at least one of a head side and a foot side of the lying surface from the tanning space into the space between the intermediate surface and the lying surface.

25. The device of claim 4, wherein a separate fan in the lower part supplies air into the space between the intermediate surface and the lying surface for modulating a temperature of the latter.

26. The device of claim 25, wherein the separate fan in connection with an air conditioner and/or a cooling device supplies temperature-modulated air into the space between the intermediate surface and the lying surface for modulating the temperature of the latter.

27. The device of claim 25, wherein the temperature-modulating air is guided through a passage from the tanning space into the space between the intermediate surface and the lying surface.

28. The device of claim 27, wherein said temperature-modulating air is guided through a passage located on at least one of a head side and a foot side of the lying surface from the tanning space into the space between the intermediate surface and the lying surface.

29. The device of claim 5, wherein the air flow supplied is drawn off on at least one of a head side and a foot side after flowing through the tanning space and is supplied to a temperature-modulating air-conditioner which feeds temperature-modulated air flow back into the tanning space.

30. The device of claim 5, wherein at least one of a head side and a foot side of the tanning space of the tanning device comprises a removable wall for closing the tanning space.

31. The device of claim 8, wherein a separate fan in the lower part supplies air into the space between the intermediate surface and the lying surface for cooling the latter.

32. The device of claim 31, wherein the separate fan in connection with an air conditioner and/or a cooling device supplies cooled air into the space between the intermediate surface and the lying surface for cooling the latter.

33. The device of claim 8, wherein said modulating air is guided through a passage from the tanning space into the space between the intermediate surface and the lying surface.

34. The device of claim 33, wherein said modulating air is guided through a passage located on at least one of a head side and a foot side of the lying surface from the tanning space into the space between the intermediate surface and the lying surface.

35. The device of claim 1, wherein a temperature modulation comprises a warming-up or a cooling of the air flow, compared to air surrounding the device.

36. The device of claim 35, wherein the temperature modulation comprises a cooling of the air flow.

37. The device of claim 1, wherein a temperature modulation may be controlled.

38. The device of claim 37, wherein the temperature modulation may be controlled by at least one of a warming device and a cooling device, and a device for adding air from an environment to the circulating air flow.

39. A process for modulating a temperature of a tanning space of a tanning device, which device comprises
a stable lower part accommodating one or more electrical appliances, switching devices and/or connecting devices; and
an upper part which is at least one of capable of being turned or swiveled away from the lower part or towards the lower part to form a substantially tunnel-shaped tanning space between the lower part and the upper part and capable of being lifted away from the lower part or lowered towards the lower part to form a substantially tunnel-shaped tanning space between the lower part and the upper part; wherein
the lower part comprises a lying surface for a user, which surface is transparent for at least tanning UV radiation and, below the lying surface, comprises at least one set of radiators which are arranged in a longitudinal direction of the tanning device for emitting radiation having at least a portion of tanning UV radiation directed into a direction of the upper part and/or at least to a part of a body of the user and which are connected directly or indirectly to the one or more electrical appliances, switching devices and/or connecting devices; and
the upper part comprises a protecting surface for the user, which surface is transparent for at least tanning UV radiation and, above the protecting surface, comprises at least one set of radiators which are arranged in a longitudinal direction of the tanning device for emitting radiation having at least a portion of tanning UV radiation directed to a direction of the lower part and/or at least a part of the body of the user; and wherein
an air flow is supplied into the tanning space substantially into a direction towards the protecting surface of the upper part of the tanning device by at least one of one or more outflow nozzles and one or more outflow channels arranged along at least longitudinal sides of the lying surface of the lower part, said air flow modulating the temperature of the tanning space when flowing therethrough.

40. A process for modulating a temperature of a body of a user in a tanning device, the tanning device comprising
a stable lower part accommodating one or more electrical appliances, switching devices and/or connecting devices; and
an upper part which is at least one of capable of being turned or swiveled away from the lower part or towards the lower part to form a substantially tunnel-shaped tanning space between the lower part and the upper part and capable of being lifted away from the lower part or lowered towards the lower part to form a substantially tunnel-shaped tanning space between the lower part and the upper part; wherein
the lower part comprises a lying surface for a user, which surface is transparent for at least tanning UV radiation and, below the lying surface, comprises at least one set of radiators which are arranged in a longitudinal direction of the tanning device for emitting radiation having at least a portion of tanning UV radiation directed into a direction of the upper part and/or at least to a part of a body of the user and which are connected directly or indirectly to the one or more electrical appliances, switching devices and/or connecting devices; and
the upper part comprises a protecting surface for the user, which surface is transparent for at least tanning UV radiation and, above the protecting surface, comprises at least one set of radiators which are arranged in a longitudinal direction of the tanning device for emitting radiation having at least a portion of tanning UV radiation directed to a direction of the lower part and/or at least a part of the body of the user; and wherein
an air flow is supplied into the tanning space substantially into a direction towards the protecting surface of the upper part of the tanning device by at least one of one or more outflow nozzles and one or more outflow channels arranged along at least longitudinal sides of the lying surface of the lower part of the tanning device, said air flow modulating the temperature of the body of the user after flowing through the tanning space.

41. The process of claim 39, wherein, in the course of modulating the temperature, the air flow is warmed or cooled, compared to air surrounding the tanning device.

42. The process of claim 40, wherein in the course of modulating the temperature the air flow is warmed or cooled, compared to air surrounding the tanning device.

43. The process of claim 39, wherein the temperature modulation is controlled.

44. The process of claim 43, wherein the temperature modulation is controlled by at least one of a warming device and a cooling device, and a device for adding air from an environment to the circulating air flow.

45. The process of claim 40, wherein the temperature modulation is controlled.

46. The process of claim 45, wherein the temperature modulation is controlled by at least one of a warming device and a cooling device, and a device for adding air from an environment to the circulating air flow.
